(19) United States
(12) Patent Application Publication
(10) Pub. No.: US 2009/0143274 A1
(43) Pub. Date: Jun. 4, 2009

(54) Surfactant Reduction Enabled by Use of Isopropylnaphthalene Sulfonate Linker

(75) Inventors: Philip C. Benes, Hamilton, OH (US); Kim M. Friloux, Columbus, OH (US)

Correspondence Address: ELMAN TECHNOLOGY LAW, P.C., P. O. BOX 209, SWARTHMORE, PA, 19081, US

(73) Assignee: NEASE CORPORATION, Blue Ash, OH (US)

(21) Appl. No.: 11/947,346

(22) Filed: Nov. 29, 2007

(51) Int. Cl. C11D 3/34

(52) U.S. Cl. 510/492

(57) ABSTRACT

Water-soluble salts of isopropylnaphthalene sulfonates function as a single linker in cleaning compositions, while maintaining cleaning performance as compared with reference formulations. A methodology is provided for reformulating detergent compositions with isopropylnaphthalene sulfonate linker. This allows for a reduction in other raw materials such as anionic and nonionic surfactants, without additional lipophilic or hydrophilic linker, providing cost savings and environmental benefit.

### BACKGROUND OF THE INVENTION

1. Field of the Invention

This invention relates to the incorporation of a single linker, isopropylnaphthalene sulfonate, in place of part of the surfactants in reference cleaning compositions such as laundry detergents and hard surface cleaners. The use of the single linker reduces the overall amount of raw materials required to produce a desired cleaning effect and thereby provides environmental and cost savings.

2. Background

Linker molecules are amphiphiles that are used to increase the surfactant-oil interactions (lipophilic linkers) or surfactant-water interactions (hydrophilic linkers) in microemulsion systems. The use of both hydrophilic and lipophilic linkers increases the solubilization and affords enhanced formulation properties for cleaning systems. See D. A. Sabatini, et al., Linker Molecules in Surfactant Mixtures. Current opinion in Colloid and Surface Science 8:316-326, 2003.

Sabatini et al reported that methyl naphthalene sulfonates function as hydrophilic linkers when coupled with lipophilic linkers, increasing the surfactant-oil separation interaction and oil solubilization capacity of a formulated cleaner. Hydrophilic linkers were introduced to compensate for the saturation effect observed for lipophilic linkers. Sabatini et al also found that when hydrophilic linkers (methyl naphthalene sulfonate) and lipophilic linkers were combined, a synergistic effect occurred that resulted in an increased solubilization enhancement over lipophilic linkers used alone. They also demonstrated that the combination of hydrophilic and lipophilic linkers can improve cleaning performance when used in cleaners.

Sodium di-isopropylnaphthalene sulfonate has been shown to have good laundering properties when used in combination with sodium lauryl ethoxy sulfate. However, the surface properties of combinations of di-isopropylnaphthalene sulfonate with conventional surfactants are generally dominated by the conventional surfactant. R. L. Burns and E. P. Duliba, Hydrotropic and Surfactant Properties of Novel Diiopropyl Naphthalene Sulfonates. Journal of Surfactants and Detergents 3(3):361-368, 2000.

U.S. Pat. No. 4,874,537 discloses the use of sodium di-isopropylnaphthalene sulfonate in a substantially nonaqueous detergent composition as a phase stabilizer.

U.S. Pat. No. 4,868,213 discloses a cleansing and disinfecting composition containing certain active ingredients such as alkali metal salts and sodium di-isobutylnaphthalene sulfonate. The composition is used to cleanse and relieve pain and itching of human skin. Sodium di-isobutylnaphthalene sulfonate is used to reduce or eliminate the irritating effects of the high pH of the alkali metal salts.

U.S. Pat. No. 5,174,870 discloses a liquid concentrate composition comprised of sodium di-isopropylnaphthalene sulfonate, trisodium nitrilotriacetate, and sodium diethanolglycinate used in cleaning metal surfaces prior to replating.

U.S. Pat. No. 5,418,128 discloses a coating composition comprising di- and tri-isopropylnaphthalene sulfonate as part of a mixture of surfactants which is applied to photographic elements.

### SUMMARY OF THE INVENTION

Water-soluble salts of isopropylnaphthalene sulfonates, especially di-isopropyl-naphthalene sulfonates, function as single linkers in detergent compositions without the use of lipophilic linkers. Isopropylnaphthalene sulfonates can be incorporated into cleaning compositions with reduced surfactant loads to provide 90% or better cleaning power of the unaltered reference compositions. The method provides a reduction in raw material cost for cleaning compositions because of reduced surfactants used in the inventive compositions. Isopropylnaphthalene sulfonates used according to the invention also provide environmental benefit by reducing the load of organic compounds in the inventive compositions while providing substantially the same cleaning power as the reference composition.

The present invention provides a reformulated cleaning composition having substantially the same cleaning power as a reference cleaning composition and having a lower total weight of organic compounds comprising:

one or more surfactants, each in an amount which has been reduced to 40% to 60% of the amount of the corresponding surfactant in the reference cleaning composition; and

a single linker consisting essentially of water-soluble salt of one or more isopropylnaphthalene sulfonates, in the amount of 10-30 weight % of the total amount of surfactant in the reference cleaning composition,

wherein the reformulated cleaning composition has at least 90% of the cleaning power of the reference cleaning composition and a lower total weight of organic compounds than the reference cleaning composition.

In one embodiment, the surfactants consist essentially of one or more nonionic surfactants.

In another embodiment, the surfactants consist essentially of one or more nonionic surfactants and one primarily or more anionic surfactants. Optionally such a composition is designed primarily to clean oily soils and has a ratio of nonionic surfactants to anionic surfactants of approximately 3 to 1. As an alternative option, such a composition is designed primarily to clean particulate soils and has a ratio of nonionic surfactants to anionic surfactants of approximately 1 to 1.

In yet another embodiment, the surfactants consist essentially of one or more nonionic surfactants, one or more anionic surfactants, and one or more amphoteric surfactants.

In still another embodiment, the surfactants consist essentially of one or more nonionic surfactants and one or more additional surfactants selected from the group consisting of betaines and water-soluble salts of alkyl sulfates.

In such compositions, the single linker desirably consists essentially of water-soluble salts of:

0-40 weight % of mono-isopropylnaphthalene sulfonate

5-100 weight % of di-isopropylnaphthalene sulfonate and
0-70 weight % of tri-isopropylnaphthalene sulfonate.

Desirably the single linker consists essentially of water-soluble salts of:

0-5 weight % of mono-isopropylnaphthalene sulfonate

80-98 weight % of di-isopropylnaphthalene sulfonate and
0-5 weight % of tri-isopropylnaphthalene sulfonate.

The reference cleaning composition may, for example, be a heavy duty laundry detergent comprising:
1-40 weight % of nonionic surfactant consisting essentially of linear alcohol ethoxylate and
1-40 weight % of anionic surfactant consisting essentially of a water-soluble salt of linear alkylbenzene sulfonate, lauryl sulfate, lauryl ether sulfate, or mixture of any of the aforesaid.

Alternatively, the reference cleaning composition may be a hard-surface cleaner comprising:
1-5 weight % of nonionic surfactant consisting essentially of amine oxide, ethoxylated alcohol, alkanolamide fatty acid, or mixture of any of the aforesaid;
1-15 weight % of anionic surfactant consisting essentially of a water-soluble salt of methyl ester sulfonate, lauryl sulfate, alkylbenzene sulfonate, ethoxylated alcohol sulfate or mixture of any of the aforesaid; and
1-35% of a builder.

The present invention provides a method of reformulating a reference cleaning composition to have substantially the same cleaning power with a lower total weight of organic compounds. This is accomplished by performing the steps of:
a. Determining the components, including one or more surfactants, of a reference cleaning composition to be reformulated;
b. Reformulating said reference cleaning composition by reducing the amounts of each of said one or more surfactants by 40-60%, and
c. Adding a single linker consisting essentially of water-soluble salt of one or more isopropylnaphthalene sulfonates, in the amount of 10-30 weight % of the total amount of surfactant in the reference cleaning composition,

wherein the reformulated cleaning composition has at least 90% of the cleaning power of the reference cleaning composition and a lower total weight of organic compounds than the reference cleaning composition.

The method of reformulating a reference cleaning composition may, for example, be used when the surfactants consist essentially of nonionic surfactant.

The method of reformulating a reference cleaning composition may also be used when the surfactants consists essentially of nonionic surfactant and anionic surfactant.

### DETAILED DESCRIPTION

### Definitions

As used herein, the following terms have the following meanings:

Reference cleaning composition—a commercial or non-commercial cleaning composition for use in household, industrial, or institutional marketplaces. Within the context of this disclosure, the term reference cleaning composition also includes test compositions used in the examples and experimental studies as controls. These latter compositions may or may not be useful as general use laundering compositions because they may lack many of the additives desired in typical laundering products. The reference cleaning compositions of the invention will typically comprise anionic and/or nonionic surfactants. Typical reference cleaning compositions are based upon known laundering formulations. For example, known formulations for cleaning compositions are described by K.-Y. Lai, Liquid Detergents, 2nd Edition, Surfactant Science Series, Volume 129, CRC Press, 2006. Another resource describing cleaning formulations is E. W. Flick, Household and Automotive Cleaners and Polishes, 3rd Edition, Park Ridge, N.J., Noyes Publications, 1986.

Examples of reference cleaning compositions include heavy duty laundry detergents, hard surface cleaners, all-purpose cleaners, spray glass cleaners, shower treatments, spray bathroom cleaners, and other detergent cleaners know to those skilled in the art.

Cleaning power—a measure of the effectiveness of a given cleaning formulation to remove soil. Cleaning power is to be determined using known standardized test methods generating cumulative test results. In cases where the value of cumulative test results of an inventive composition as compared to the reference composition is 90% or more, the inventive composition is said to have achieved equal or increased cleaning power.

For laundering products, one performs a test using a Terg-o-Tometer (U.S. Testing Co.) or equivalent, in accordance with ASTM D3050-05, desirably modified to include a soak time which reflects standard conditions of use in the industry. See Example 1, below. In such tests, one starts with swatches of fabric that have been soiled with any of various standard compositions and then compares the difference in reflectance of washed swatches with the reflectance of corresponding unwashed swatches. The cumulative test result of a reference composition for each soil is compared with the corresponding result for the inventive composition to determine a percentage reflectance. The percentage reflectance determined from each soil is a measure of the cleaning power of the inventive composition on that specific type of soil. This measure of cleaning power is used for determining whether any particular composition has met the criteria for the present invention wherein the composition is to be labeled for laundering of that specific type of soil.

The overall cleaning power of a proposed laundering product is determined by averaging the results of multiple tests on different types of soils. If the average of the multiple tests is 90% or more, the proposed product is said to have achieved equal or increased overall cleaning power as compared to the reference composition. The overall cleaning power is used for determining whether any particular composition has met the criteria of the present invention for general applicability as a laundering cleaner.

Alternatively, if one does not have access to the test ASTM D3050-05 as described above, other standardized laundry tests methods may be used to approximate a determination of cleaning power. These would include other tests developed by ASTM International, Inc. e.g. D2960-98, “Standard Test Method for Controlled Laundering Test Using Naturally Soiled Fabrics and Household Appliances” and D4265-98, “Standard Guide for Evaluating Stain Removal in Home Laundering.”

For hard-surface cleaning products, one performs a Gardner Scrub test in accordance with ASTM test method D4488 (see Example 4, below), by determining the difference in reflectance of soiled test squares before and after cleaning with a Gardner Straight-Line Washability Apparatus to determine the percent soil removal. The percent soil removal is calculated and compared. If the percent reflectance is 90% or more, then the inventive composition is said to have achieved equal or increased cleaning power for use as a hard surface cleaner on the specific soil type tested.

The overall cleaning power is determined by averaging the results of multiple tests on different types of soil. The overall cleaning power is used for determining whether any particular composition has met the criteria of the present invention for general applicability as a hard surface cleaner.

Alternatively, if one does not have access to a Gardner Scrub test as described above, cleaning power of a hard surface cleaner can also be approximated by ASTM test method D5343-97 “Standard guide for Evaluating Cleaning Performance of Ceramic Tile Cleaners.”

Linker—a compound used to increase the surfactant-oil interactions (a lipophilic linker) or surfactant-water interactions (a hydrophilic linker) in microemulsion systems. It is known that the use of both a hydrophilic and a lipophilic linker in a cleaning composition increases the solubilization and affords enhanced formulation properties for cleaning systems. Alkyl naphthalene sulfonates, particularly methylnaphthalene sulfonates, have been shown to act as hydrophilic linkers when used in tandem with lipophilic linkers to increase solubilization of cleaner formulations.

Single linker—a single amphiphile used to increase solubilization capacity in microemulsion systems. A single linker is used in the presence of surfactants only, and no other hydrophilic or lipophilic linker is necessary in order to produce favorable cleaning characteristics. Isopropylnaphthalene sulfonate acts as a single linker in the inventive formulations of this patent, synergistically increasing the effectiveness of the cleaning compositions. Use of a single linker in a cleaning composition obviates the necessity or desirability of incorporating along with it a lipophilic linker into a typical cleaning composition.

Water-soluble salt—an ionic compound consisting of one or more cations associated with isopropylnaphthalene sulfonate anion that has at least 30% by weight solubility in water at room temperature. Suitable cations for this invention include, but are not limited to, lithium, sodium, potassium, and ammonium.

Isopropylnaphthalene sulfonate—compounds of Formula I wherein n is 1-3 and X⁺ is a suitable cation which renders the sulfonate to be a water soluble salt. Representative cations X⁺ include, but are not limited to, sodium, potassium, lithium, and ammonium.

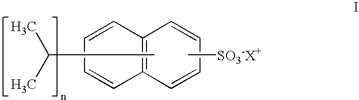

The isopropyl substituents may be attached at any position of the naphthalene rings. Therefore a multiplicity of isomers may be present in a given sample of isopropylnaphthalene sulfonate. Representative isopropylnaphthalene sulfonates include water soluble salts of mono-isopropylnaphthalene sulfonate (I, n=1), di-isopropylnaphthalene sulfonate (I, n−2), and tri-isopropylnaphthalene sulfonate (I, n=3).

Builders—substances added to cleaning formulations to increase the cleaning action. Builders can act as softening, buffering, and emulsifying agents in cleaning formulations. Suitable builders for use in the invention include, but are not limited to, carbonates, phosphates, silicates, citrates, EDTA salts, NTA, and polyacrylates.

Surfactants—substances that reduce the surface tension of water and allow water to wash surfaces better. Surfactants can be uncharged (nonionic), negatively charged (anionic), or positively charged (cationic). Generally detergents comprise anionic or nonionic surfactants. Suitable nonionic surfactants for use in the invention include linear alcohol ethoxylates, amine oxides, and alkanolamides fatty acids. Suitable anionic surfactants include linear alkylbenzene sulfonates, ethoxylated alcohol sulfates, lauryl sulfates, lauryl ether sulfates, and methyl ester sulfates. Other suitable nonionic and anionic surfactants are known to those skilled in the art.

Hydrotropes—coupling agents to solubilize incompatible ingredients within a detergent formulation. They are not surfactants. They are used to stabilize solutions, modify viscosity, limit phase separation at low temperatures, and reduce foaming. Suitable hydrotropes include cumene sulfonates, xylene sulfonates, and toluene sulfonates.

The present invention relates to the use of isopropylnaphthalene sulfonate salts of Formula I as a single linker system in cleaning compositions without the use of a lipophilic linker. The resulting inventive cleaning compositions offer a lower cost alternative to experimental and known reference cleaning compositions.

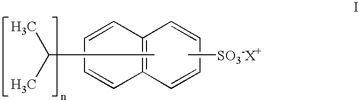

Soluble salts of isopropylnaphthalene sulfonates of Formula I are well known in the art and various mixtures of them are commercially available. The substances preferred for use in the practice of the present invention are mixtures of the naphthalene sulfonate salts of Formula I wherein n is 1-3, preferably 2. The isopropyl substituent(s) may be at any position on the naphthalene ring. The sulfonate group may be at any position on the naphthalene ring. Typical commercially available mixtures of these compounds comprise sodium salts wherein 0-40% of the mixture is monosubstituted (n=1), 5-100% is disubstituted (n=2), and 0-70% is trisubstituted (n=3). Unless otherwise stated, all percentages given herein are by weight of the salt or other compound.

Preferred mixtures of compounds of Formula I are those wherein the mixture comprises compounds in which n=1 (0-5%), n=2 (80-98%), and n=3 (0-5%).

Most preferred is a mixture wherein n=1 (about 5%), n=2 (about 90%), and n=3 (about 1%). This is commercially available as Naxan® DIL (Nease Corp.) and within this disclosure is generally referred to as Naxan® DIL.

In one embodiment, cleaning compositions of this invention comprise a mixture of isopropylnaphthalene sulfonate salts of Formula I as a linker (1-10%), a nonionic surfactant (1-40%), and an anionic surfactant (1-40%). Additional components in the mixture may include buffers, builders, bleach, stabilizers, enzymes, brighteners, defoamers, disinfectants, enzyme stabilizers, hydrotropes, amphoteric surfactants, preservatives, fragrances, and colorants, all of which are well known in the art.

Suitable nonionic surfactants include linear alcohol ethoxylates, amine oxides, and alkanolamide fatty acids. Other suitable nonionic surfactants are known to those skilled in the art.

Suitable anionic surfactants include linear alkylbenzene sulfonates, ethoxylated alcohol sulfates, lauryl sulfates, lauryl ether sulfates, and methyl ester sulfates. Other suitable anionic surfactants are known to those skilled in the art.

Suitable builders include carbonates, phosphates, silicates, citrates, EDTA salts, NTA, and polyacrylates. Suitable hydrotropes include cumene sulfonates, xylene sulfonates, and toluene sulfonates.

In accordance with the present invention, isopropylnaphthalene sulfonate compounds of Formula I are used as a single linker, allowing one to reduce the amount of surfactants that would conventionally have been used in a detergent formulation, which is referred to herein as a “reference” composition. The method of this invention allows one to maintain or increase cleaning power as compared to the reference composition while producing an inventive composition having a reduced amount of organic compounds. To achieve this result, one reformulates a reference cleaning composition by including only 40-60% of each original surfactant, and adding the linker of the present invention in the amount of about 10-30% of the total weight of surfactant present in the reference composition.

It is preferred that the surfactant components be reduced to 45-55% as compared to the reference composition, and desirably the isopropylnaphthalene sulfonate salt linker is added in an amount equal to about 15-25%, preferably about 20%, of the total weight of surfactants in the reference cleaning composition.

Cleaning compositions having reduced surfactant percentages and containing the linker of the present invention can have an equal or better cleaning power than the reference cleaning compositions. We consider that a reformulated cleaning composition having a cleaning power of 90% or better as measured by conventional test methods, as further described below, is an acceptable equivalent to the reference cleaning composition. The cleaning compositions of this invention are effective on many test soils (stains) including dust/sebum, ground in clay, bandy black clay, and mineral oil/soot.

The following experimental details are provided to complete the present disclosure of the invention, including the best mode currently contemplated for practicing it. The scope of this invention is to be understood with reference to this entire disclosure including the claims appended hereto.

### EXAMPLES

In each of the following Examples, the term “Reference” refers to a reference cleaning composition as defined above, and the term “Inventive” refers to a composition formulated in accordance with the present invention that corresponds to the reference cleaning composition. Whether or not a particular inventive composition so formulated meets the criteria of the present invention depends on its cleaning power, determined as described herein. In general, that cleaning power will be the overall cleaning power as measured for the particular inventive composition. However, when the composition is to be labeled for cleaning a particular type of soil, then the cleaning power determined for that soil type is the relevant criterion.

For each of the formulation charts in the examples below, the components of the formulations are expressed on a “100% actives” basis.

### Example 1

### Heavy Duty Laundry Detergent—Terg-o-Tometer Wash Evaluations

A mixture of Naxan® DIL, sodium isopropylnaphthalene sulfonate of Formula I (5% n=1, 90% n=2, 1% n=3), was shown to function as a single linker in cleaning compositions that are based on laundry detergents. The effect of the single linker has been shown to replace a portion of the surfactants in two particular cleaning compositions which contain a combination of nonionic and anionic surfactants. The two compositions tested were based on two types of soils targeted in the cleaning industry: 1) formulations designed to clean primarily oily soils (3 parts nonionic to 1 part anionic surfactants) and 2) formulations designed to clean primarily particulate soils (1 part nonionic to 1 part anionic surfactants).

A reference composition and an inventive composition in accordance with the present invention were produced for evaluation. In each case, the cleaning power performance of a reference composition was compared with a cleaner embodying the present invention. The inventive composition was formulated using 50% of the total surfactants of the reference composition. The remaining 50% surfactant was replaced with 20% sodium isopropylnaphthalene sulfonate. The total active concentrations tested were 100% of the original cleaner (Reference) versus 50% of the original cleaner surfactants plus 20% linker reformulated according to the invention (Inventive).

The tests were performed on pre-stained soils from Testfabrics, Inc. The four soils tested were dust/sebum, ground in clay, bandy black clay, and mineral oil/soot. The results of the Terg-o-Tometer tests are reported in units of reflectance as recorded using a Hunter Color Quest XE, the reflectance being the difference between the unwashed swatch and the washed swatch. Duplicate swatches were washed and analyzed in each test.

In rating the results of the Terg-o-Tometer tests, the target of cleaning (difference in reflectance of the Reference vs. Inventive) was set at 90% reflectance of the Reference swatch in each test. This is a method of rating used by third party labs in Terg-o-Tometer test studies when determining detergency. If the difference in reflectance is within this range, the tests is said to show equal cleaning. Increased cleaning is recorded when the reflectance of the Inventive sample is greater than that of the Reference sample.

In the Terg-o-Tometer tests, the nonionic surfactant used was an alcohol ethoxylate (7EO, Neodol® 25-7 [Shell Oil Co.]) and the anionic surfactant was a linear alkyl benzene sulfonate (LAS, Naxsoft® 40S [Nease Corp.]). The method involved the use of a Terg-o-Tometer with multiple washings, based on test conditions as stated in ASTM D3050-05, modified to include a soak time which reflects standard conditions of use in the industry. The soiled cloth swatches were allowed to soak for 3 minutes in the wash solution before the wash cycle was started in the modified ASTM D3050-05 tests. The tests were performed using a Terg-o-Tometer (US Testing Co.) under the following conditions:

Method: ASTM Method D3050-05, as modified

| | |
|---|---|
| Amount of Water Wash | 1 liter |
| Detergent dosage | 0.25% detergent |
| Agitation | 90 cycles per minute |
| Premix | 1 minute |
| Soak | 3 minutes |
| Wash | 10 minutes |
| Rinse | 3 minutes |
| Color Analysis Instrument | Hunter ColorQuest XE |

Each formulation was evaluated under the following wash conditions:

| Water | |
|---|---|
| Temperature | Hardness |
| 70° F. | 150 ppm |
| 70° F. | 300 ppm |
| 100° F. | 150 ppm |
| 100° F. | 300 ppm |

a) Formulation Type 1: 3 parts nonionic to 1 part anionic surfactant

| | Reference | Inventive |
|---|---|---|
| Nonionic - Linear | 12.6% | 6.3% |
| alcohol ethoxylate | | |
| Anionic - Linear | 4.2% | 2.1% |
| alkylbenzene | | |
| sulfonate | | |
| Linker - Sodium | — | 3.3% |
| isopropylnaphthalene | | |
| sulfonate | | |
| (Naxan ® DIL) | | |
| Water | q.s. to 100% | q.s. to 100% |

Reference Formulation Type 1 generally gives desirable results with oily soils.

b) Formulation Type 2: 1 part nonionic to 1 part anionic surfactant

| | Reference | Inventive |
|---|---|---|
| Nonionic - Linear | 8.4% | 4.2% |
| alcohol ethoxylate | | |
| Anionic - Linear | 8.4% | 4.2% |
| alkylbenzene | | |
| sulfonate | | |
| Linker - Sodium | — | 3.3% |
| isopropylnaphthalene | | |
| sulfonate | | |
| (Naxan ® DIL) | | |
| Water | q.s. to 100% | q.s. to 100% |

Reference Formulation Type 2 generally gives desirable results with particulate soils.

TABLE 1-1
Cumulative reflectance results: Formulation Type 1 (3:1) washings with
Naxan ® DIL

| | Soils | | | |
|---|---|---|---|---|
| | Dust/ | Ground | | |
| | Sebum | in Clay | Bandy Black Clay | Mineral Oil/Soot |
| Reference | 40.0 | 22.6 | 11.4 | 15.0. |
| Inventive | 36.0 | 21.0 | 11.7 | 18.9 |
| % Reflectance | 90.1% | 92.9% | 102.6% | 126.0% |

| | |
|---|---|
| Cleaning Power (average % Reflectance of the four | 102.9% |
| soil tests) | |

TABLE 1-2
Cumulative reflectance results: Formulation Type 2 (1:1) washings with
Naxan ® DIL

| | Soils | | | |
|---|---|---|---|---|
| | | Ground | Bandy | |
| | Dust/Sebum | in Clay | Black Clay | Mineral Oil/Soot |
| Reference | 34.1 | 9.1 | 11.8 | 16.1 |
| Inventive | 32.5 | 8.4 | 10.9 | 16.2 |
| % Reflectance | 95.3% | 92.3% | 92.4% | 100.6% |

| | |
|---|---|
| Cleaning Power (average % Reflectance of the four | 95.2% |
| soil tests) | |

The results in Tables 1-1 and 1-2 are cumulative test results conducted under the four soil wash conditions described above. The sum total of the results from each of the four tests with the reference formulation was compared with the sum total of the results obtained from each of the four tests with the inventive formulation. The percentage determined from the comparison represents the cleaning power of a given inventive formulation on a given test soil.

Both Table 1-1 and 1-2 show that on each test soil type (Dust/Sebum, Ground in Clay, Bandy Black Clay, Mineral Oil/Soot), the 90% level of cleaning was achieved, indicating equal and/or increased cleaning.

### Example 2

### Terg-o-Tometer Tests Comparing Other Isopropylnaphthalene Sulfonate Products with Naxan DIL

To compare the cleaning power of Naxan® DIL to three other commercial products, similar Terg-o-Tometer testing was performed using the same reference compositions, Formulation Type 1 and Formulation Type 2, as described in Example 1. Naxan® DIL, Morwet® IP, Alkanol® XC, and Selogen HR were incorporated into separate inventive compositions as described for Naxan DIL in Example 1. The resulting inventive compositions were tested on four soils and percent reflectance measured. The cumulative results for each Reference composition and Inventive composition were tabulated for each soil and reported as a cumulative data point as reported in Table 2-1 and Table 2-2.

Percentages of Isopropylnaphthalene Sulfonates in Commercial Products.

| | Naxan ® DIL | Morwet ® IP | Alkanol ® XC | Selogen ® HR |
|---|---|---|---|---|
| Mono | 4.9 | 27.4 | 2.3 | 34.6 |
| Di | 89.5 | 8.6 | 32.9 | 29.0 |
| Tri | 1.2 | 41.9 | 59.2 | 8.7 |

TABLE 2-1
Cumulative results of differences in reflectance (cleaning power) for various soils
with Formulation Type 1 (3:1) washings with isopropylnaphthalene products

| | | Products | | | |
|---|---|---|---|---|---|
| | | Naxan ® | Morwet ® | Alkanol ® | Selogen ® |
| Soils | | DIL | IP | XC | HR |
| Dust/Sebum | Reference | 40.0 | 23.2 | 25.3 | 26.2 |
| | Inventive | 36.0 | 21.55 | 23.8 | 23.8 |
| Cleaning Power for | % Reflectance | 90.1% | 92.8% | 94.1% | 90.8% |
| Dust/Sebum | | | | | |
| Ground in Clay | Reference | 22.6 | 16.8 | 22.1 | 15.6 |
| | Inventive | 21.0 | 15.7 | 20.7 | 13.1 |
| Cleaning Power for | % Reflectance | 92.9% | 93.4% | 93.6% | 83.9% |
| Ground in Clay | | | | | |
| Bandy Black Clay | Reference | 11.4 | 10.5 | 11.6 | 11.6 |
| | Inventive | 11.7 | 10.5 | 12.0 | 11.4 |
| Cleaning Power for | % Reflectance | 102.6% | 100% | 103.4% | 98.2% |
| Bandy Black Clay | | | | | |
| Mineral Oil/Soot | Reference | 15.0 | 17.5 | 28.5 | 26.1 |
| | Inventive | 18.9 | 18.3 | 31.6 | 26.1 |
| Cleaning Power for | % Reflectance | 126.0% | 104.5 | 110.8% | 100.0% |
| Mineral Oil/Soot | | | | | |
| Overall Cleaning Power | | 102.9% | 97.7% | 100.5% | 93.2% |
| (average % Reflectance | | | | | |
| of the four soil tests) | | | | | |

Table 2-1 shows that the inventive compositions of Formulation Type 1 (3:1 nonionic to anionic surfactants) comprising Naxan®, Morwet®, Alkanol®, and Selogen have an overall cleaning power of 90% or higher. Therefore each of these compositions is an inventive composition for general laundering usage. Alternatively, all of the compositions based on Formulation Type 1, except for Selogen for use on Ground in Clay, are inventive compositions within the scope of the invention for use on each specific soil type.

TABLE 2-2
Cumulative results of differences in reflectance (cleaning power) for various soils
with Formulation Type 2 (1:1) washings with isopropylnaphthalene products

| | | Products | | | |
|---|---|---|---|---|---|
| | | Naxan ® | Morwet ® | Alkanol ® | Selogen ® |
| Soils | | DIL | IP | XC | HR |
| Dust/Sebum | Reference | 34.1 | 21.0 | 19.3 | 19.7 |
| | Inventive | 32.5 | 18.1 | 17.1 | 19.9 |
| Cleaning Power for | % Reflectance | 95.3% | 86.2% | 88.6% | 101.0% |
| Dust/Sebum | | | | | |
| Ground in Clay | Reference | 9.1 | 10.5 | 11.9 | 10.5 |
| | Inventive | 8.4 | 13.4 | 11.5 | 6.3 |
| Cleaning Power for | % Reflectance | 92.3% | 128.4% | 96.6% | 60% |
| Ground in Clay | | | | | |
| Bandy Black Clay | Reference | 11.8 | 11.3 | 13.8 | 15.5 |
| | Inventive | 10.9 | 10.0 | 13.5 | 12.1 |
| Cleaning Power for | % Reflectance | 92.4% | 88.4% | 97.8% | 78.6% |
| Bandy Black Clay | | | | | |
| Mineral Oil/Soot | Reference | 16.1 | 17.0 | 29.4 | 31.1 |
| | Inventive | 16.2 | 20.2 | 29.3 | 27.0 |
| Cleaning Power for | % Reflectance | 100.6% | 118.8% | 99.6% | 86.8% |
| Mineral Oil/Soot | | | | | |
| Overall Cleaning Power | | 95.2% | 105.5% | 95.7% | 81.6% |
| (average % Reflectance | | | | | |
| of the four soil tests) | | | | | |

Table 2-2 shows that the inventive compositions of Formulation Type 2 (1:1 nonionic to anionic surfactants) comprising Naxan®, Morwet®, and Alkanol® have an overall cleaning power of 90% or higher. Therefore each of these compositions satisfies the criteria of the present invention as laundering formulations.

The overall cleaning power for the tested composition of Formulation Type 2 comprising Selogen is less than 90%. That composition does not meet the criteria of the present invention for a general-purpose laundry detergent. However, as labeled specifically for the cleaning of the tested soils, cleaning performance as measured by soil removal of particulate and oily soils evaluated on dust/sebum soil fabrics, the tested composition of Formulation Type 2 comprising Selogen is within the scope of the present invention.

### Example 3

### Physical Properties Tests Including Comparison of Other Anionic Surfactants

Four application performance properties tests were performed with the reference and inventive compositions as formulated in Example 1. The physical properties tests performed were the Surface Tension, Ross-Miles Foam, Draves Wetting, and Interfacial Tension tests. These properties are accepted in industry as measures which can be used to predict if cleaners will perform as they are intended. When performing these comparative tests, the anionic surfactant, linear alkylbenzene sulfonate (LAS), was replaced by two other anionic surfactants, sodium lauryl ether sulfate (SLES) and sodium lauryl sulfate (SLS), respectively. Each set of formulations, Reference and Inventive, with these surfactants were tested for comparison. This was done to establish whether or not the other anionic surfactants were useful in the inventive compositions.

### a) Surface Tension

Measurements made using a Kruse Digital Tensiometer KIOST with the ring method at concentrations of 0.01% and 0.1% aqueous dilution. Results are reported in dynes, mN/m.

TABLE 3-1
Comparative surface tensions of formulations
using different anionic surfactants

| | | Conc., | Experimental Results, dynes (mN/m) | | |
|---|---|---|---|---|---|
| | Formulation | % Aq. | LAS | SLES | SLS |
| Surface | 1:1 | 0.01 | 38.7 | 38.4 | 37.9 |
| Tension | 1:1 | 0.1 | 31.9 | 31.2 | 31.0 |
| | 3:1 | 0.01 | 36.4 | 37.0 | 35.9 |
| | 3:1 | 0.1 | 31.5 | 30.6 | 31.0 |

Surface Tension measurements of the six formulations made with the three different anionic surfactants were comparative. The results show that anionic surfactants, SLES and SLS, are interchangeable with LAS when used with single linkers.

### b) Ross-Miles Foam

Tests were carried out according to ASTM method D1173-53. Measurements were made at concentrations of 0.5% and 0.05% aqueous dilutions. Results are reported as millimeters of foam height measured initially.

TABLE 3-2
Comparative initial foam heights of formulations
using different anionic surfactants

| | | Conc., | Experimental Results: foam height, cm | | |
|---|---|---|---|---|---|
| | Formulation | % Aq. | LAS | SLES | SLS |
| Ross | 1:1 | 0.05 | 7.2 | 5.7 | 5.8 |
| Miles | 1:1 | 0.5 | 11.3 | 11.6 | 11.7 |
| Foam | 3:1 | 0.05 | 6.0 | 5.8 | 5.0 |
| | 3:1 | 0.5 | 11.1 | 12.0 | 11.5 |

In laundry applications, foam can be detrimental. Anionic surfactants tend to produce foam. In the Ross-Miles Foam tests performed, the results of SLES and SLS compare with LAS. The anionic surfactants are interchangeable.

### c) Draves Wetting

Method: ASTM D2281-68-5 gram cotton skein, 3 gram hook. Measurements were made at concentrations of 1.0% and 0.5% aqueous dilutions. Results are reported in seconds of elapsed time to wet the skein.

TABLE 3-3
Comparative wetting of formulations
using different anionic surfactants

| | | Conc., | Experimental Results, time, seconds | | |
|---|---|---|---|---|---|
| | Formulation | % Aq. | LAS | SLES | SLS |
| Draves | 1:1 | 0.5 | 27 | 29 | 36 |
| Wetting | 1:1 | 1.0 | 29 | 16 | 17 |
| | 3:1 | 0.5 | 14 | 35 | 32 |
| | 3:1 | 1.0 | 15 | 15 | 18 |

The results of the Draves Wetting test revealed that minor differences were observed between the three anionic surfactants when evaluated at two different concentrations and formulations. Based on these results it is expected that these anionic surfactants would provide suitable wettability in a formulated laundry detergent.

### d) Interfacial Tension

Measurements made using a Kruse Digital Tensiometer KIOST using the ring method at concentrations of 0.1% and 0.05% aqueous dilutions. Results are reported in dynes, mN/m.

TABLE 3-4
Comparative interfacial tensions of formulations
using different anionic surfactants

| | | Conc., | Experimental Results, dynes (mN/m) | | |
|---|---|---|---|---|---|
| | Formulation | % Aq. | LAS | SLES | SLS |
| Interfacial | 1:1 | 0.05 | 12.7 | 14.5 | 14.9 |
| Tension | 1:1 | 0.1 | 9.8 | 10.5 | 11.0 |
| | 3:1 | 0.05 | 12.6 | 14.0 | 12.8 |
| | 3:1 | 0.1 | 9.3 | 9.6 | 9.8 |

Results in interfacial measurements closely compare. The low interfacial tensions are indicative of increased solubility at the liquid to liquid surfaces an attribute that helps suspend soil in the wash water to be removed in rinsing. The results in this test are very positive and show that the anionic surfactants are indeed interchangeable.

These data revealed that the properties tested using the other anionic surfactants were comparable indicating that cleaners with linkers in combination with LAS, SLES and SLS perform comparably and can be used in formulations where linker technology is incorporated.

### Example 4

### Hard Surface Cleaner Evaluation—Gardner Scrub Test

The Gardner Scrub Test was conducted to study hard surface cleaning. Formulations of the reference cleaning compositions were based on published hard surface cleaner formulations. For example see General Purpose Spray & Wipe Cleaner, Bulletin No. 575, Stepan Company. Results are shown in Table 4-1. The Reference and Inventive samples were prepared such that the comparison was made between 100% surfactant load versus 50% of the original surfactants with 20% linker added. The last column shows typical ranges of components that comprise formulation of the invention which may be used.

TABLE 4-1
Hard Surface Cleaner - General Purpose Spray &Wipe Cleaner
Formulations

| | | | Typical |
|---|---|---|---|
| | Reference | Inventive | Ranges |
| Sodium Citrate | 2.0 | 2.0 | 0-10% |
| Sodium methyl ester sulfonate | 3.6 | 1.8 | 0-15% |
| Sodium isopropylnaphthalene | — | 1.54 | 1-10% |
| sulfonate (Naxan ® DIL) | | | |
| Sodium lauryl sulfate | 2.1 | 1.05 | 0-5% |
| Amine oxide | 2 | 1 | 0-5% |
| DI Water | q.s. to 100% | q.s. to 100% | q.s to 100% |

The cleaning performance of the two formulations was compared according to test method: ASTM D4488, using D4488-A2 kitchen soil on painted wallboard and D4488-A3 pigmented oily soil on vinyl composite flooring.

To six panels of wallboard, grease was applied from ASTM D4488-A2. To 12-inch tiles of vinyl composite, oily soil pigmented with iron per ASTM D4488-A3 was applied. The substrates were baked for 30 minutes at 100° C. and allowed to cool before cutting them into 4-inch squares. The reflectance was measured on all test pieces with a Photovolt Reflectometer.

The soiled test squares were mounted in the tray of a Gardner Straight-Line Washability Apparatus and a damp sponge placed in the carriage. To the soiled surface, 2 ml of test product was applied and allowed to stand for 30 seconds, then scrubbed for ten cycles with the damp sponge. Three panels of each soil/substrate combination were cleaned with each test product.

The reflectance of each product was measured before and after cleaning. The percent soil removal was calculated and averaged for each set of replicates. In each test, the percentage difference of the Inventive as compared to Reference was greater than 90%.

TABLE 4-2
Percent Soil Removal - reported as reflectance

| Soil | Substrate | Reference | Inventive | % Reflectance |
|---|---|---|---|---|
| D4488-A2 | Painted Wallboard | 38.4 | 42.7 | 111.2% |
| D4488-A3 | Vinyl Composite | 61.6 | 57.3 | 93.1% |
| | Total | 100.0 | 100.0 | |
| | | | | Overall |
| | | | | Cleaning |
| | | | | Power (average |
| | | | | % Reflectance |
| | | | | of the |
| | | | | two soil |
| | | | | tests) 102.2% |

The results of Table 4-2 show that the cleaning power (percent reflectance) of the Reference and Inventive. The results show that improved cleaning power was observed for each soil type. There is no significant difference in cleaning power between the Reference and the Inventive formulations. The overall cleaning power is 102.2% for these tests. These results show that this particular formulation is within the scope of this invention generally and with respect to each of the tested soil types.

### Example 5

### Hard Surface Cleaner Evaluation—Gardner Scrub Test—LAS substitution

A second test was conducted using the Gardner Scrub Test to determine if linear alkyl benzene sulfonate could be substituted for the main anionic surfactant (sodium methyl ester sulfonate in Table 4-1) and achieve the same results. Again the Reference cleaning compositions were based on a published Hard Surface Cleaner formulation and are shown in Table 4-1. The Reference and Inventive samples were prepared such that the comparison was made between 100% surfactant load versus 50% of the original surfactants with 20% linker added. The last column shows typical ranges of components that comprise formulation of the invention which may be used.

TABLE 5-1
Hard Surface Cleaner - General Purpose Spray &Wipe Cleaner
Formulations

| | | | Typical |
|---|---|---|---|
| | Reference | Inventive | Ranges |
| Sodium Citrate | 2.0 | 2.0 | 0-10% |
| Linear alkylbenzene sulfonate | 3.6 | 1.8 | 0-15% |
| Sodium isopropylnaphthalene | — | 1.54 | 1-10% |
| sulfonate (Naxan ® DIL) | | | |
| Sodium lauryl sulfate | 2.1 | 1.05 | 0-5% |
| Amine oxide | 2 | 1 | 0-5% |
| DI Water | q.s. to 100% | q.s. to 100% | q.s to 100% |

The test and cleaning evaluation was carried out as in Example 4. Results are reported in the same format as Example 4.

TABLE 5-2
Percent Soil Removal - reported as reflectance

| Soil | Substrate | Reference | Inventive | % Reflectance |
|---|---|---|---|---|
| D4488-A2 | Painted Wallboard | 52.3 | 51.8 | 99.0% |
| D4488-A3 | Vinyl Composite | 47.7 | 48.2 | 101.0% |
| | Total | 100.0 | 100.0 | |
| | | | | Overall |
| | | | | Cleaning |
| | | | | Power |
| | | | | (average |
| | | | | % Reflectance |
| | | | | of the two soil |
| | | | | tests) 100.0% |

The reflectance of each product was measured before and after cleaning. The percent soil removal was calculated and averaged for each set of replicates. In each test, the percentage difference between the reflectance of the Inventive when compared to the Reference and a cleaning power (percent reflectance) of greater than 90% was observed for the Inventive. The results show that cleaning power was maintained for each soil type. There is no significant difference in cleaning power between the Reference and the Inventive formulations. The overall cleaning power is 100.0% for these tests. These results show that this particular formulation is within the scope of this invention generally and with respect to each of the tested soil types.

### Example 6

### Formulation of Structured Heavy Duty Liquid Detergent

Table 6-1 shows how a typical formulation profile for a structured heavy duty liquid detergent would be modified according to the invention. The last column shows typical ranges of components that comprise formulation of the invention which may be used.

TABLE 6-1
Structured Heavy Duty Liquid Formulations

| | | | | Typical |
|---|---|---|---|---|
| | | Reference | Inventive | Range |
| Ingredient | Function | (wt %) | (wt %) | (wt %) |
| Sodium linear | Anionic | 28.0 | 14.0 | 0-30 |
| alkylbenzene | | | | |
| sulfonate⁽¹⁾ | surfactant | | | |
| Sodium alkyl ether | Anionic | 10.0 | 5.0 | 0-10 |
| sulfate⁽²⁾ | surfactant | | | |
| Alcohol ethoxylate⁽³⁾ | Nonionic | 10.0 | 5.0 | 0-10 |
| | surfactant | | | |
| Sodium | Linker | 0.0 | 9.6 | 1-10 |
| isopropylnaphthalene | | | | |
| sulfonate⁽⁴⁾ | | | | |
| Sodium carbonate | Builder | 20.0 | 20.0 | 0-25 |
| Zeolite | Builder | 20.0 | 20.0 | 0-25 |
| Sodium perborate | Bleach | 7.0 | 7.0 | 0.0-10.0 |
| Polymer | Stabilizer | 0.5 | 0.5 | 0.0-1.0 |
| Protease | Enzyme | 1.0 | 1.0 | 0.0-1.5 |
| Florescent whitening | Brightener | 0.25 | 0.25 | 0.0-0.5 |
| agent | | | | |
| Boric Acid | Enzyme | 3.13 | 3.13 | 0.0-5.0 |
| | Stabilizer | | | |
| Preservative | | 0.1 | 0.1 | 0.05-0.2 |
| Fragrance | | 0.01 | 0.01 | 0.0-0.6 |
| Colorant | | 0.01 | 0.01 | 0.0-0.2 |
| Water | | q.s. | q.s. | q.s. |

Surfactants as commercially available products:
⁽¹⁾BIO-SOFT ® (Stepan Company), CALSOFT ® (Pilot Chemical Co.), NAXSOFT ® (Nease Corporation), WITCONATE ® (Akzo Nobel)
⁽²⁾BIO-SOFT ® (Stepan Company), CALFOAM ® (Pilot Chemical Co.), NAXOLATE ® (Nease Corporation), SULFOCHEM ® (Chemron Corp.), WITCOLATE ® (Akzo Nobel Surfactants)
⁽³⁾ALFONIC ® (Sasol North America, Inc.), BIO-SOFT ® (Stepan Company), CHEMONIC ® (Chemron Corp.), NEODOL ® (Shell Chemical Co.), SURFONIC ® (Huntsman Corporation), WITCONOL ® (Akzo Nobel Surfactants), TOMADOL ® (Air Products and Chemicals, Inc.)
⁽⁴⁾NAXAN ® DIL (Nease Corp.)

### Example 7

### Formulation of an Unstructured Heavy Duty Liquid Detergent

Table 7-1 shows how a typical formulation profile for an unstructured heavy duty liquid detergent would be modified according to the invention. The last column shows typical ranges of components that comprise formulation of the invention which may be used.

TABLE 7-1
Unstructured Heavy Duty Liquid Formulations

| | | | | Typical |
|---|---|---|---|---|
| | | Reference | Inventive | Range |
| Ingredient | Function | (wt %) | (wt %) | (wt %) |
| Sodium linear | Anionic | 12.0 | 6.0 | 0-15 |
| alkylbenzene | | | | |
| sulfonate⁽¹⁾ | surfactant | | | |
| Sodium alkyl ether | Anionic | 12.0 | 6.0 | 0-15 |
| sulfate⁽²⁾ | surfactant | | | |
| Alcohol ethoxylate⁽³⁾ | Nonionic | 10.0 | 5.0 | 0-15 |
| | surfactant | | | |
| Sodium | Linker | 0 | 6.8 | 1-10 |
| isopropylnaphthalene | | | | |
| sulfonate⁽⁴⁾ | | | | |
| Sodium Citrate | Builder | 8.0 | 8.0 | 0-10 |
| Zeolite | Builder | 15.0 | 15.0 | 0-25 |
| Monoethanolamine | Buffer | 2.5 | 2.5 | 0-5 |
| Soap | Defoamer | 2.5 | 2.5 | 0-5 |
| Protease | Enzyme | 1.0 | 1.0 | 0-1.5 |
| Florescent whitening | Brightener | 0.25 | 0.25 | 0-0.5 |
| agent | | | | |
| Boric Acid | Enzyme | 2.5 | 2.5 | 0-5 |
| | Stabilizer | | | |
| Ethanol | Solvent | 2.5 | 2.5 | 0-5 |
| Sodium xylene | Hydrotrope | 8.0 | 8.0 | 0-10 |
| sulfonate | | | | |
| Preservative | | 0.2 | 0.2 | 0.05-0.2 |
| Fragrance | | 0.3 | 0.3 | 0.0-0.6 |
| Colorant | | 0.1 | 0.1 | 0.0-0.2 |
| Water | | q.s. | q.s. | q.s. |

Surfactants as commercially available products:
⁽¹⁾BIO-SOFT ® (Stepan Company), CALSOFT ® (Pilot Chemical Co.), NAXSOFT ® (Nease Corporation), WITCONATE ® (Akzo Nobel)
⁽²⁾BIO-SOFT ® (Stepan Company), CALFOAM ® (Pilot Chemical Co.), NAXOLATE ® (Nease Corporation), SULFOCHEM ® (Chemron Corp.), WITCOLATE ® (Akzo Nobel Surfactants)
⁽³⁾ALFONIC ® (Sasol North America, Inc.), BIO-SOFT ® (Stepan Company), CHEMONIC ® (Chemron Corp.), NEODOL ® (Shell Chemical Co.), SURFONIC ® (Huntsman Corporation), WITCONOL ® (Akzo Nobel Surfactants), TOMADOL ® (Air Products and Chemicals, Inc.)
⁽⁴⁾NAXAN ® DIL (Nease Corp.)

### Example 8

### Formulation of Specialty Liquid Household Surface Cleaners

Table 8-1 shows how a typical formulation profile for a liquid dilutable all-purpose cleaner would be modified according to the invention. The last column shows typical ranges of components that comprise formulation of the invention which may be used.

TABLE 8-1
Liquid Dilutable All-Purpose Cleaner Formulations

| | | Reference | Inventive | Typical |
|---|---|---|---|---|
| Function | Examples | (wt %) | (wt %) | Range (wt %) |
| Anionic | Alkylbenzene sulfonate⁽¹⁾, | 20.0 | 10 | 0-35 |
| surfactant | ethoxylated alcohol sulfate⁽²⁾, | | | |
| Nonionic | Ethoxylated alcohol⁽³⁾, amine | 15.0 | 7.5 | 0-35 |
| surfactant | oxide⁽⁵⁾, alkanolamide fatty | | | |
| | acid⁽⁶⁾ | | | |
| Linker | Sodium isopropylnaphthalene | 0 | 7.0 | 1-10 |
| | sulfonate⁽⁴⁾ | | | |
| Hydrotropes | Sodium cumene sulfonate⁽⁷⁾, | 8.0 | 8.0 | 0-10 |
| | sodium xylene sulfonate⁽⁸⁾ | | | |
| Builder | Carbonates (more rarely | 5.0 | 5.0 | 0-10 |
| | phosphates), silicates, citrates, | | | |
| | EDTA salts, polyacrylates | | | |
| pH adjuster | Ammonia, sodium hydroxide, | 5.0 | 5.0 | 0-10 |
| | magnesium hydroxide, | | | |
| | alkanolamines | | | |
| Solvent | Alcohol (pine oil, benzyl | 25.0 | 25.0 | 0.5-50 |
| | alcohol, or lower carbon number | | | |
| | alcohols), glycol ether | | | |
| | (Carbitol ®, Dowanol ®, etc.) d- | | | |
| | limonene | | | |
| Disinfectant | Hypochlorite bleach, Pine oil, | 8.0 | 8.0 | 0-15 |
| | other lower carbon number | | | |
| | alcohols, quaternary ammonium | | | |
| | compounds | | | |
| “Shine” | Polyacrylates, polyethylene | 10.0 | 10.0 | 0-25 |
| polymers and | glycol, polyvinyl pyrrolidone, | | | |
| other benefits | organosilanes | | | |
| Perfume, color, | | 1.0 | 1.0 | 0.1-3 |
| etc. | | | | |
| Water | | q.s. | q.s. | q.s. |

Surfactants as commercially available products:
⁽¹⁾BIO-SOFT ® (Stepan Company), CALSOFT ® (Pilot Chemical Co.), NAXSOFT ® (Nease Corporation), WITCONATE ® (Akzo Nobel)
⁽²⁾BIO-SOFT ® (Stepan Company), CALFOAM ® (Pilot Chemical Co.), NAXOLATE ® (Nease Corporation), SULFOCHEM ® (Chemron Corp.), WITCOLATE ® (Akzo Nobel Surfactants)
⁽³⁾ALFONIC ® (Sasol North America, Inc.), BIO-SOFT ® (Stepan Company), CHEMONIC ® (Chemron Corp.), NEODOL ® (Shell Chemical Co.), SURFONIC ® (Huntsman Corporation), WITCONOL ® (Akzo Nobel Surfactants), TOMADOL ® (Air Products and Chemicals, Inc.)
⁽⁴⁾NAXAN ® DIL (Nease Corp.)
⁽⁵⁾AMMONYX ® (Stepan Company), CALAMIDE ® (Pilot Chemical Co.), CHEMOXIDE ® (Chemron Corp.), NAXIDE ® (Nease Corp.), RHODAMOX ® (Rhodia, Inc.)
⁽⁶⁾ALKAMIDE ® (Rhodia, Inc.), AMADOL ® (Akzo Nobel Surfactants), AMIDEX ® (Chemron Corp.), CALAMIDE ® ⁽Pilot Chemical Co.), NINOL ® (Stepan Company), NAXAMIDE ® (Nease Corp.), WITCAMIDE ® (Akzo Nobel Surfactants)
⁽⁷⁾NAXONATE ® (Nease Corp.), PILOT ® (Pilot Chemical Co.), STEPANATE ® (Stepan Company), SULFOCHEM ® (Chemron Corp.)

### Example 9

### Formulation of Spray All-Purpose Cleaners

Table 9-1 shows how a typical formulation profile for a spray all-purpose cleaner formulation would be modified according to the invention. The last column shows typical ranges of components that comprise formulation of the invention which may be used.

TABLE 9-1
Spray All-Purpose Cleaner Formulations

| | | Reference | Inventive | Typical |
|---|---|---|---|---|
| Function | Examples | (wt %) | (wt %) | Range (wt %) |
| Anionic surfactant | Alkylbenzene sulfonate⁽¹⁾, | 8.0 | 4.0 | 0-10 |
| | ethoxylated alcohol sulfate⁽²⁾ | | | |
| Nonionic | Ethoxylated alcohol⁽³⁾, | 6.0 | 3.0 | 0-10 |
| surfactant | alkanolamide fatty acid⁽⁶⁾ | | | |
| | amine oxide⁽⁵⁾ | | | |
| Linker | Sodium isopropylnaphthalene | 0.0 | 2.8 | 1-10 |
| | sulfonate⁽⁴⁾ | | | |
| Builder | Carbonates (more rarely | 8.0 | 8.0 | 0-10 |
| | phosphates), silicates, citrates, | | | |
| | EDTA salts, NTA | | | |
| pH adjuster | Ammonia, sodium hydroxide, | 6.0 | 6.0 | 0.1-10 |
| | magnesium hydroxide, | | | |
| | alkanolamines or citric acid | | | |
| Solvent | Alcohol (pine oil, benzyl | 9.0 | 9.0 | 0.5-10 |
| | alcohol, or lower carbon | | | |
| | number alcohols), glycol ether | | | |
| | (Carbitol ®, Dowanol ®, etc.), | | | |
| | d-limonene | | | |
| Disinfectant | Pine oil, C2-C3 alcohol, | 4.0 | 4.0 | 0-5 |
| | quaternary ammonium | | | |
| | compounds | | | |
| Bleach | Hydrogen peroxide | 5.0 | 5.0 | 0-10 |
| Antistreak | Polystyrene/maleic anhydride, | 0.5 | 0.5 | 0.1-2 |
| polymers | polyethylene glycol, etc. | | | |
| Perfume, color, | | 0.5 | 0.5 | 0.1-2 |
| etc. | | | | |
| Water | | q.s. | q.s. | q.s. |

Surfactants as commercially available products:
⁽¹⁾BIO-SOFT ® (Stepan Company), CALSOFT ® (Pilot Chemical Co.), NAXSOFT ® (Nease Corporation), WITCONATE ® (Akzo Nobel)
⁽²⁾BIO-SOFT ® (Stepan Company), CALFOAM ® (Pilot Chemical Co.), NAXOLATE ® (Nease Corporation), SULFOCHEM ® (Chemron Corp.), WITCOLATE ® (Akzo Nobel Surfactants)
⁽³⁾ALFONIC ® (Sasol North America, Inc.), BIO-SOFT ® (Stepan Company), CHEMONIC ® (Chemron Corp.), NEODOL ® (Shell Chemical Co.), SURFONIC ® (Huntsman Corporation), WITCONOL ® (Akzo Nobel Surfactants), TOMADOL ® (Air Products and Chemicals, Inc.)
⁽⁴⁾NAXAN ® DIL (Nease Corp.)
⁽⁵⁾AMMONYX ® (Stepan Company), CALAMIDE ® (Pilot Chemical Co.), CHEMOXIDE ® (Chemron Corp.), NAXIDE ® (Nease Corp.), RHODAMOX ® (Rhodia, Inc.)

### Example 10

### Formulation of Spray Glass Cleaners

Table 10-1 shows how a typical formulation profile for a spray glass cleaner would be modified according to the invention. The last column shows typical ranges of components that comprise formulation of the invention which may be used.

TABLE 10-1
Spray Glass Cleaner Formulations

| | | Reference | Inventive | Typical |
|---|---|---|---|---|
| Ingredient | Examples | (wt %) | (wt %) | Range (wt %) |
| Anionic surfactant | Alkylbenzene sulfonate⁽¹⁾, | 0.75 | 0.37 | 0-1 |
| | ethoxylated alcohol sulfate⁽²⁾ | | | |
| Nonionic surfactant | Ethoxylated alcohol⁽³⁾, | 2.0 | 1.0 | 0.1-3 |
| | alkanolamide fatty acid⁽⁶⁾, | | | |
| | amine oxide⁽⁵⁾ | | | |
| Amphoteric | Betaines, sulfobetaines | 6.0 | 3.0 | 0-10 |
| surfactant | | | | |
| Builder | Carbonates, silicates, citrates, | 1.0 | 1.0 | 0-2 |
| Linker | Sodium isopropylnaphthalene | 0.0 | 1.75 | 1-10 |
| | sulfonate⁽⁴⁾ | | | |
| pH adjuster | Ammonia, sodium hydroxide, | 5.0 | 5.0 | 0-10 |
| | alkanolamines or citric acid | | | |
| Solvent | Lower carbon number | 30.0 | 30.0 | 0.5-40 |
| | alcohols), glycol ether, | | | |
| | (Carbitol ®, Dowanol ®, etc.) | | | |
| Antistreak, antifog | Silanes, ethoxylated silicones, | 0.5 | 0.5 | 0-1 |
| polymers | polyethylene glycol, | | | |
| | polyvinyl alcohols | | | |
| Perfume, color, etc. | | 0.1 | 0.1 | 0.001-0.5 |
| Water | | q.s. | q.s. | q.s. |

Surfactants as commercially available products:
⁽¹⁾BIO-SOFT ® (Stepan Company), CALSOFT ® (Pilot Chemical Co.), NAXSOFT ® (Nease Corporation), WITCONATE ® (Akzo Nobel)
⁽²⁾BIO-SOFT ® (Stepan Company), CALFOAM ® (Pilot Chemical Co.), NAXOLATE ® (Nease Corporation), SULFOCHEM ® (Chemron Corp.), WITCOLATE ® (Akzo Nobel Surfactants)
⁽³⁾ALFONIC ® (Sasol North America, Inc.), BIO-SOFT ® (Stepan Company), CHEMONIC ® (Chemron Corp.), NEODOL ® (Shell Chemical Co.), SURFONIC ® (Huntsman Corporation), WITCONOL ® (Akzo Nobel Surfactants), TOMADOL ® (Air Products and Chemicals, Inc.)
⁽⁴⁾NAXAN ® DIL (Nease Corp.)
⁽⁵⁾AMMONYX ® (Stepan Company), CALAMIDE ® (Pilot Chemical Co.), CHEMOXIDE ® (Chemron Corp.), NAXIDE ® (Nease Corp.), RHODAMOX ® (Rhodia, Inc.)
⁽⁶⁾ALKAMIDE ® (Rhodia, Inc.), AMADOL ® (Akzo Nobel Surfactants), AMIDEX ® (Chemron Corp.), CALAMIDE ® (Pilot Chemical Co.), NINOL ® (Stepan Company), NAXAMIDE ® (Nease Corp.), WITCAMIDE ® (Akzo Nobel Surfactants)

### Example 11

### Formulation of Shower Treatments

Table 11-1 shows how a typical formulation profile for a shower treatment would be modified according to the invention. The last column shows typical ranges of components that comprise formulation of the invention which may be used.

TABLE 11-1
Shower Treatment Formulations

| | | Reference | Inventive | Typical |
|---|---|---|---|---|
| Ingredient | Examples | (wt, %) | (wt %) | Range (wt %) |
| Nonionic surfactant | Ethoxylated alcohol⁽³⁾, APG, | 2.5 | 1.25 | 0.5-3 |
| | amine oxide⁽⁵⁾ | | | |
| Additional | Betaines, alkyl sulfate⁽⁹⁾, | 5.0 | 2.5 | 0-10 |
| surfactant | octyl pyrrolidone | | | |
| Linker | Sodium | 0.0 | 1.5 | 1-10 |
| | isopropylnaphthalene | | | |
| | sulfonate⁽⁴⁾ | | | |
| pH adjuster | Ammonium hydroxide, | q.s. | q.s. | q.s. |
| | morpholine, citric acid | | | |
| Hard water chelator | EDTA, NTA | 1.0 | 1.0 | 0.1-3 |
| Solvent | Lower carbon number | 6.0 | 6.0 | 1-8 |
| | alcohols, glycol ether, | | | |
| | (Carbitol ®, Dowanol ®, etc.) | | | |
| Disinfectant | Quaternary ammonium | 0.3 | 0.3 | 0-0.5 |
| Perfume, color, etc. | | 0.0007 | 0.0007 | 0.0005-0.001 |
| Distilled or | | q.s. | q.s. | q.s. |
| dionized | | | | |
| water | | | | |

Surfactants as commercially available products:
⁽³⁾ALFONIC ® (Sasol North America, Inc.), BIO-SOFT ® (Stepan Company), CHEMONIC ® (Chemron Corp.), NEODOL ® (Shell Chemical Co.), SURFONIC ® (Huntsman Corporation), WITCONOL ® (Akzo Nobel Surfactants), TOMADOL ® (Air Products and Chemicals, Inc.)
⁽⁴⁾NAXAN ® DIL (Nease Corp.)
⁽⁵⁾AMMONYX ® (Stepan Company), CALAMIDE ® (Pilot Chemical Co.), CHEMOXIDE ® (Chemron Corp.), NAXIDE ® (Nease Corp.), RHODAMOX ® (Rhodia, Inc.)
⁽⁹⁾CALFOAM ® (Pilot Chemical Co.), NAXOLATE ® (Nease Corp.), STEPANOL ® (Stepan Company), SULFOCHEM ® (Chemron Corp.), WITCOLATE ® (Akzo Nobel Surfactants)

### Example 12

### Formulations of Spray Bathroom Cleaners

Table 12-1 shows how a typical formulation profile for a spray bathroom cleaner would be modified according to the invention. The last column shows typical ranges of components that comprise formulation of the invention which may be used.

TABLE 12-1
Spray Bathroom Cleaner Formulations

| | | Reference | Inventive | Typical |
|---|---|---|---|---|
| Function | Examples | (wt %) | (wt %) | Range (wt %) |
| Anionic surfactant | Alkylbenzene sulfonate⁽¹⁾, | 5.0 | 2.5 | 0-6 |
| | alkyl sulfate⁽⁹⁾, ethoxylated | | | |
| | alcohol sulfate⁽²⁾ | | | |
| Nonionic surfactant | Ethoxylated alcohol⁽³⁾, | 2.0 | 1.0 | 0-3 |
| | alkanolamide fatty acid, | | | |
| | amine oxide⁽⁵⁾ | | | |
| Linker | Sodium | 0.0 | 1.4 | 0.5-5 |
| | isopropylnaphthalene | | | |
| | sulfonate⁽⁴⁾ | | | |
| Amphoteric | Betaines, sulfobetaines | 1.0 | 1.0 | 0-2 |
| surfactant | | | | |
| Acid | Phosphoric, dicarboxylic | 5.0 | 5.0 | 0.5-10 |
| | (like glutaric), citric, | | | |
| | sulfamic, acetic | | | |
| Solvent | Lower carbon number | 8.0 | 8.0 | 0-10 |
| | alcohols, glycol ether, | | | |
| | (Carbitol ®, Dowanol ®, etc.) | | | |
| Disinfectant | Quaternary ammonium | 2.0 | 2.0 | 0.1-3 |
| | surfactants | | | |
| Bleach (may also | Acid: peroxide | 2.0 | 2.0 | 0-3 |
| disinfect) | Alkaline: hypochlorite | | | |
| | bleach | | | |
| Polymers for | Xanthan gum, polyacrylate, | 0.1 | 0.1 | 0-0.1 |
| thickening, water | polyvinylpyrrolidone | | | |
| sheeting, etc. | | | | |
| Perfume, color, etc. | | 0.07 | 0.07 | 0.05-1 |
| Water | | q.s. | q.s. | q.s. |

Surfactants as commercially available products:
⁽¹⁾BIO-SOFT ® (Stepan Company), CALSOFT ® (Pilot Chemical Co.), NAXSOFT ® (Nease Corporation), WITCONATE ® (Akzo Nobel)
⁽²⁾BIO-SOFT ® (Stepan Company), CALFOAM ® (Pilot Chemical Co.), NAXOLATE ® (Nease Corporation), SULFOCHEM ® (Chemron Corp.), WITCOLATE ® (Akzo Nobel Surfactants)
⁽³⁾ALFONIC ® (Sasol North America, Inc.), BIO-SOFT ® (Stepan Company), CHEMONIC ® (Chemron Corp.), NEODOL ® (Shell Chemical Co.), SURFONIC ® (Huntsman Corporation), WITCONOL ® (Akzo Nobel Surfactants), TOMADOL ® (Air Products and Chemicals, Inc.)
⁽⁴⁾NAXAN ® DIL (Nease Corp.)
⁽⁵⁾AMMONYX ® (Stepan Company), CALAMIDE ® (Pilot Chemical Co.), CHEMOXIDE ® (Chemron Corp.), NAXIDE ® (Nease Corp.), RHODAMOX ® (Rhodia, Inc.)
⁽⁹⁾CALFOAM ® (Pilot Chemical Co.), NAXOLATE ® (Nease Corp.), STEPANOL ® (Stepan Company), SULFOCHEM ® (Chemron Corp.), WITCOLATE ® (Akzo Nobel Surfactants)

It is to be understood that modifications or alterations of the compositions set forth in these examples may be made, in accordance with the principles set forth in the foregoing disclosure, without departing from the spirit and the scope of the invention as set forth in the appended claims.

What is claimed is:

1. A reformulated cleaning composition having substantially the same cleaning power as a reference cleaning composition and having a lower total weight of organic compounds comprising:
one or more surfactants, each in an amount which has been reduced to 40% to 60% of the amount of the corresponding surfactant in the reference cleaning composition; and
a single linker consisting essentially of water-soluble salt of one or more isopropylnaphthalene sulfonates, in the amount of 10-30 weight % of the total amount of surfactant in the reference cleaning composition,
wherein the reformulated cleaning composition has at least 90% of the cleaning power of the reference cleaning composition and a lower total weight of organic compounds than the reference cleaning composition.

2. The reformulated cleaning composition of claim 1, wherein said one or more surfactants consists essentially of one or more nonionic surfactants.

3. The reformulated cleaning composition of claim 1, wherein said one or more surfactants consists essentially of one or more nonionic surfactants and one or more anionic surfactants.

4. The reformulated cleaning composition of claim 3, wherein the composition has a ratio of nonionic surfactants to anionic surfactants of approximately 3 to 1.

5. The reformulated cleaning composition of claim 3, wherein the composition has a ratio of nonionic surfactants to anionic surfactants of approximately 1 to 1.

6. The reformulated cleaning composition of claim 1, wherein said one or more surfactants consists essentially of one or more nonionic surfactants, one or more anionic surfactants, and one or more amphoteric surfactants.

7. The reformulated cleaning composition of claim 1, wherein said one or more surfactants consists essentially of one or more nonionic surfactants and one or more additional surfactants selected from the group consisting of betaines, and water-soluble salts of alkyl sulfates.

8. The reformulated cleaning composition of claim 1, wherein said single linker consists essentially of water-soluble salts of:
0-40 weight % of mono-isopropylnaphthalene sulfonate
5-100 weight % of di-isopropylnaphthalene sulfonate and
0-70 weight % of tri-isopropylnaphthalene sulfonate.

9. The reformulated cleaning composition of claim 1, wherein said single linker consists essentially of water-soluble salts of:
0-5 weight % of mono-isopropylnaphthalene sulfonate
80-98 weight % of di-isopropylnaphthalene sulfonate and
0-5 weight % of tri-isopropylnaphthalene sulfonate.

10. The reformulated cleaning composition of claim 1, wherein the reference cleaning composition is a heavy duty laundry detergent comprising:
1-40 weight % of nonionic surfactant consisting essentially of linear alcohol ethoxylate and
1-40 weight % of anionic surfactant consisting essentially of a water-soluble salt of linear alkylbenzene sulfonate, lauryl sulfate, lauryl ether sulfate or mixture of any of the aforesaid.

11. The reformulated cleaning composition of claim 1, wherein the reference cleaning composition is a hard-surface cleaning cleaner comprising:
1-5 weight % of nonionic surfactant consisting essentially of amine oxide, ethoxylated alcohol, alkanolamide fatty acid or mixture of any of the aforesaid;
1-15 weight % of anionic surfactant consisting essentially of a water-soluble salt of methyl ester sulfonate, lauryl sulfate, alkylbenzene sulfonate, ethoxylated alcohol sulfate or mixture of any of the aforesaid; and
1-35 weight % of a builder.

12. A method of reformulating a reference cleaning composition to have substantially the same cleaning power with a lower total weight of organic compounds comprising the steps of:
a. Determining the components, including one or more surfactants, of a reference cleaning composition to be reformulated;
b. Reformulating said reference cleaning composition by reducing the amounts of each of said one or more surfactants by 40-60%, and
c. Adding a single linker consisting essentially of water-soluble salt of one or more isopropylnaphthalene sulfonates, in the amount of 10-30 weight % of the total amount of surfactant in the reference cleaning composition,
wherein the reformulated cleaning composition has at least 90% of the cleaning power of the reference cleaning composition and a lower total weight of organic compounds than the reference cleaning composition.

13. The method of reformulating a reference cleaning composition according to claim 12 wherein said one or more surfactants consists essentially of nonionic surfactant.

14. The method of reformulating a reference cleaning composition according to claim 12 wherein said one or more surfactants consists essentially of nonionic surfactant and anionic surfactant.

15. The method of reformulating a reference cleaning composition according to claim 12, wherein said one or more surfactants consists essentially of one or more nonionic surfactants, one or more anionic surfactants, and one or more amphoteric surfactants.

16. The method of reformulating a reference cleaning composition according to claim 12, wherein said one or more surfactants consists essentially of one or more nonionic surfactants and one or more additional surfactants selected from the group consisting of betaines and water-soluble salts of alkyl sulfates.

17. The method of reformulating a reference cleaning composition according to claim 12, wherein said single linker consists essentially of water-soluble salts of:
0-40 weight % of mono-isopropylnaphthalene sulfonate
5-100 weight % of di-isopropylnaphthalene sulfonate and
0-70 weight % of tri-isopropylnaphthalene sulfonate.

18. The method of reformulating a reference cleaning composition according to claim 12, wherein said single linker consists essentially of water-soluble salts of:
0-5 weight % of mono-isopropylnaphthalene sulfonate
80-98 weight % of di-isopropylnaphthalene sulfonate and
0-5 weight % of tri-isopropylnaphthalene sulfonate.

19. The method of reformulating a reference cleaning composition according to claim 12, wherein the reference cleaning composition is a heavy duty laundry detergent comprising:
1-40 weight % of nonionic surfactant consisting essentially of linear alcohol ethoxylate and
1-40 weight % of anionic surfactant consisting essentially of a water-soluble salt of linear alkylbenzene sulfonate, lauryl sulfate, lauryl ether sulfate or mixture of any of the aforesaid.

20. The method of reformulating a reference cleaning composition according to claim 12, wherein the reference cleaning composition is a hard-surface cleaning cleaner comprising:
1-5 weight % of nonionic surfactant consisting essentially of amine oxide, ethoxylated alcohol, alkanolamide fatty acid or mixture of any of the aforesaid;
1-15 weight % of anionic surfactant consisting essentially of a water-soluble salt of methyl ester sulfonate, lauryl sulfate, alkylbenzene sulfonate, ethoxylated alcohol sulfate or mixture of any of the aforesaid; and
1-35 weight % of a builder.
